(19) United States
(12) Patent Application Publication
(10) Pub. No.: US 2019/0250902 A1
(43) Pub. Date: Aug. 15, 2019

(54) ON-BOARD UPDATE SYSTEM, ON-BOARD UPDATE DEVICE, AND COMMUNICATION DEVICE UPDATE METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka (JP)

(72) Inventor: Hiroshi Tateishi, Yokkaichi, Mie (JP)

(21) Appl. No.: 16/329,425

(22) PCT Filed: Aug. 28, 2017
(86) PCT No.: PCT/JP2017/030695

§ 371 Date: Feb. 28, 2019

(30) Foreign Application Priority Data
Sep. 2, 2016 (JP) 2016-172063

(51) Int. Cl. G06F 8/65; B60R 16/023; G07C 5/00

(52) U.S. Cl. CPC G06F 8/65; G07C 5/008; B60R 16/023

(57) ABSTRACT

An on-board update system, an on-board update device, and a communication device update method provided herein enable an update process in a communication device installed in a vehicle, without limiting the use of the vehicle for the convenience of the user. The on-board update device includes: a driving information acquisition unit; a driving information transmission unit; an update information acquisition unit. The on-board update device updates a program stored in a storage unit of the communication device. The server device includes: a driving information receiving unit receiving the driving information transmitted from the on-board update device; an update timing determination unit determines, based on the received information, a timing of an update process in the communication device to be performed by the on-board update device; and a start command transmission unit transmits an update process start command to the on-board update device, based on the determined timing.

### CROSS-REFERENCE TO RELATED APPLICATIONS

This application is the U.S. national stage of PCT/JP2017/030695 filed Aug. 28, 2017, which claims priority of Japanese Patent Application No. JP 2016-172063 filed Sep. 2, 2016.

### TECHNICAL FIELD

The present disclosure relates to an on-board update system, an on-board update device, and a communication device update method, for updating programs or data in communication devices installed in a vehicle.

### BACKGROUND

A vehicle is conventionally equipped with a plurality of communication devices such as ECUs (Electronic Control Units), which are connected via communication lines such as CAN (Controller Area Network) buses and thereby capable of transmitting and receiving information to/from each other. In each ECU that is in charge of vehicle control or a like process, a processor such as a CPU (Central Processing Unit) retrieves and executes a program stored in a storage unit such as a flash memory or EEPROM (Electrically Erasable Programmable Read Only Memory). The program or data stored in the storage unit of each ECU needs to be updated with a new program or data, for example, when required to add a function, to correct a fault, to upgrade, etc. In this case, an update program or data is transmitted via a communication line to the ECU to be updated.

In a program update system proposed by JP 2015-103163A, update data for a control device to be updated contain not only an update control program for the control device but also a computer program that enables means for calculating a digest value relating to the update control program, means for deciding whether the updated control device operates normally, and means for returning the result of the decision. The control device to be updated receives the update data, and updates the control program with the update control program contained in the received update data. Then, the control device runs the computer program and decides whether the updated control device operates normally, thus being capable of checking the validity of the program update.

Recently, an automatic update system has been developed to update ECUs in a vehicle. Such an automatic update system acquires update programs or data from outside the vehicle by wireless communication or the like, and automatically updates the ECUs using the acquired programs or data. In this system, the timing of an update process in each ECU is of great importance. While a program or data stored in a storage unit of an ECU is being updated, this ECU cannot perform its usual process until the update process is complete. As a result, the vehicle is unavailable until an update process in every ECU is complete, which limits the use of the vehicle and causes inconvenience to the user.

An object of the present disclosure, made in view of such circumstances, is to provide an on-board update system, an on-board update device, and a communication device update method, each of which enables an update process in a communication device installed in a vehicle, without limiting the use of the vehicle for the convenience of the user.

### SUMMARY

An on-board update system according to an aspect of the present disclosure includes: a communication device installed in a vehicle; a server device provided outside the vehicle; and an on-board update device including an update information acquisition unit and an update information transmission unit, and configured to update a program or data stored in a storage unit of the communication device. The update information acquisition unit is configured to acquire an update program or data for updating the communication device from the server device. The update information transmission unit is configured to transmit the update program or data acquired by the update information acquisition unit to the communication device. The on-board update device also includes: a driving information acquisition unit configured to acquire driving information of the vehicle; and a driving information transmission unit configured to transmit the information acquired by the driving information acquisition unit to the server device. The server device includes: a driving information receiving unit configured to receive the driving information of the vehicle transmitted from the on-board update device; an update timing determination unit configured to determine, based on the information received by the driving information receiving unit, a timing of an update process in the communication device to be performed by the on-board update device; and a start command transmission unit configured to transmit an update process start command to the on-board update device, based on the timing determined by the update timing determination unit. The on-board update device further includes a start command receiving unit configured to receive the update process start command for the communication device from the server device. The update information transmission unit is configured to transmit the update program or data to the communication device in accordance with the start command received by the start command receiving unit.

In the on-board update system according to another aspect of the present disclosure, the server device further includes: a driving information storage unit configured to store and accumulate the information received by the driving information receiving unit; and a no-driving time slot estimation unit configured to estimate a time slot when the vehicle is not driving, based on the information stored in the driving information storage unit. The update timing determination unit is configured to determine the timing of the update process, based on the time slot estimated by the no-driving time slot estimation unit.

In the on-board update system according to another aspect of the present disclosure, the no-driving time slot estimation unit is configured to extract one or more time slots when the vehicle was not driving, based on the information for a predetermined number of days stored in the driving information storage unit, and to estimate a longest time slot in the one or more extracted time slots as the time slot when the vehicle is not driving.

In the on-board update system according to another aspect of the present disclosure, the update timing determination unit is configured to determine the timing of the update process in a time range around a middle time of the time slot estimated by the no-driving time slot estimation unit, the time range corresponding to a time required for the update process in the communication device.

In the on-board update system according to another aspect of the present disclosure, the on-board update device further includes: a battery information acquisition unit configured to acquire information about an amount of electric power charged in a battery in the vehicle; and an updatability decision unit configured to decide whether the update process in the communication device is executable, in accordance with the amount of electric power charged in the battery as acquired by the battery information acquisition unit. The update information transmission unit is configured to transmit the update program or data to the communication device, if the updatability decision unit decides that the update process is executable.

In the on-board update system according to another aspect of the present disclosure, the on-board update device further includes: an IG (ignition) state acquisition unit configured to acquire a state of an IG signal in the vehicle; and a selection receiving unit configured to receive a selection that authorizes or suspends the update process in the communication device, if the IG signal changes from off to on after the updatability decision unit has decided that the update process is not executable. The update information transmission unit is configured to transmit the update program or data to the communication device, if the selection receiving unit receives a selection that authorizes the update process.

In the on-board update system according to another aspect of the present disclosure, the on-board update device further includes: an IG (ignition) state acquisition unit configured to acquire a state of an IG signal in the vehicle; and an update discontinuation unit configured, if the IG signal is on, to discontinue the transmission of the update program or data by the update information transmission unit and to recover an operation of the communication device using a pre-update program or data.

An on-board update device according to still another aspect of the present disclosure updates a program or data stored in a storage unit of a communication device installed in a vehicle. The on-board update device includes: an update information acquisition unit configured to acquire an update program or data for updating the communication device, from a server device provided outside the vehicle; and an update information transmission unit configured to transmit the update program or data acquired by the update information acquisition unit, to the communication device. The on-board update device further includes: a driving information acquisition unit configured to acquire driving information of the vehicle; and an update timing determination unit configured to determine a timing of an update process in the communication device, based on the information acquired by the driving information acquisition unit. The update information transmission unit is configured to transmit the update program or data to the communication device, in accordance with the timing determined by the update timing determination unit.

A communication device update method according to still another aspect of the present disclosure updates a program or data stored in a storage unit of a communication device installed in a vehicle, by acquiring an update program or data for updating the communication device from a server device provided outside the vehicle, and transmitting the acquired update program or data to the communication device. The method includes the steps of acquiring driving information of the vehicle; transmitting the acquired information to the server device; determining a timing of an update process in the communication device, by the server device that has received the transmitted information, based on the received information; transmitting an update process start command, by the server device, based on the determined timing; receiving the update process start command from the server device; and transmitting the update program or data to the communication device in accordance with the received start command.

According to an aspect of the present disclosure, the on-board update device performs an update process of the program or data in each communication device installed in the vehicle. The on-board update device acquires an update program or data from the server device or the like installed outside the vehicle. If more than one communication device needs updating, the on-board update device acquires an update program or data for each communication device. Alternatively, the on-board update device may apply one update program or data to the update process of more than one communication device. The on-board update device transmits, at a predetermined timing, the update program or data acquired from the server device to the communication device to be updated. The communication device that has received the update program or data from the on-board update device updates its program or data by writing the received update program or data in its own storage unit. The timing when the on-board update device acquires an update program or data from the server device and the timing when the on-board update device transmits the update program or data to the communication device may not necessarily be the same. For example, the on-board update device may acquire an update program or data from the server device and may store the acquired update program or data while the vehicle is driving. After the vehicle is parked and the engine has stopped, the on-board update device may transmit the stored update program or data to the communication device to be updated.

In the on-board update system according to an aspect of the present disclosure, the server device determines the timing when the on-board update device transmits an update program or data to the communication device to be updated, namely, the timing of the update process in the communication device. For this purpose, the on-board update device acquires and transmits driving information of the vehicle to the server device. Based on the driving information received from the on-board update device, the server device determines the timing of the update process and transmits an update process start command to the on-board update device. The on-board update device receives the start command from the server device, starts to transmit the update program or data to the communication device in accordance with the received start command, and thus starts the update process in the communication device.

The server device that has determined the timing of the update process may be configured to transmit a start command to the on-board update device just at the determined timing, and to cause the on-board update device to start the update process in the communication device, immediately or without delay, when the on-board update device receives the start command. Alternatively, the server device that has determined the timing of the update process may be configured to transmit a start command that prescribes the time of the update process or the like, to the on-board update device before the prescribed time, and to cause the on-board update device to start the update process at the prescribed time after the on-board update device has received the start command. In this case, the server device may transmit the start command that prescribes the timing of the update process together with the update program or data, to the on-board update device.

In the thus configured on-board update system according to an aspect of the present disclosure, the server device can accumulate driving information of the vehicle, can determine a suitable update timing for the communication device (e.g., the time slot when the vehicle is highly unlikely to be driving), can transmit a start command to the on-board update device, and can cause the on-board update device to update the communication device at the determined timing.

In another aspect of the present disclosure, the server device stores and accumulates the driving information received from the on-board update device. The server device refers to the accumulated driving information and estimates the time slot when the vehicle is not driving.

For example, the server device refers to the accumulated driving information for a predetermined number of days (e.g., one-month or the like) and extracts, from this period, one or more time slots when the vehicle was not driving. If only one time slot is extracted, the server device may take this time slot as the time slot when the vehicle is not driving. If extracted time slots are dispersed, the server device selects the longest time slot as the time slot when the vehicle is not driving. Then, the server device calculates the middle time of the estimated time slot (namely, if the estimated time slot is between 1:00 a.m. and 3:00 a.m., the middle time is 2:00 a.m.) and determines the timing of an update process in a predetermined time range around this middle time. The predetermined time range may be, for example, the time required for the update process in the communication device.

Owing to these arrangements, the server device can transmit an update process start command to the on-board update device such that the update process can be performed in the time slot when the vehicle is highly unlikely to be driving.

According to another aspect of the present disclosure, the on-board update device acquires information about the amount of electric power charged in the battery in the vehicle. Prior to the update process, the on-board update device decides whether the update process is executable in accordance with the amount of electric power charged in the battery. The on-board update device decides whether the update process is executable, for example, depending on whether the amount of electric power charged in the battery is greater than a predetermined threshold value. If the on-board update device decides that an update process is executable based on the amount of electric power charged in the battery, the on-board update device starts to transmit the update program or data to the communication device. This arrangement can prevent, for example, a loss of battery power or similar troubles during the update process.

According to another aspect of the present disclosure, the on-board update device acquires the state of the IG (ignition) signal in the vehicle. If the on-board update device decides that an update process is not executable in accordance with the amount of electric power charged in the battery, the update process is suspended. Later, when the IG signal changes from off to on, the on-board update device tries the suspended update process. In this case, however, the change of the IG signal to the on state possibly means that the user intends to drive the vehicle. Once the update process has started, the vehicle is unavailable until the update process is complete. Hence, the on-board update device asks the user whether to authorize an update process and receives the user's selection that authorizes or suspends the update process. Based on the received selection, the on-board update device starts the update process in the communication device only if the update process is authorized. This arrangement ensures that the user can use the vehicle without being disturbed by an update process.

According to another aspect of the present disclosure, if the IG signal is the on state at the timing of an update process in the communication device or if the IG signal changes from off to on during an update process, the on-board update device discontinues the transmission of the update program or data to the communication device, and allows the target communication device to recover the operation using the pre-update program or data. This arrangement enables the user to use the vehicle even when the update process is in progress.

According to another aspect of the present disclosure, the on-board update device may be configured to store driving information, to determine the timing of an update process based on the driving information, and to perform other relevant processes, instead of the server device. The thus configured on-board update device can determine the update timing suitably, even in a situation where the on-board update device cannot communicate with the server device frequently.

### Advantageous Effects of Disclosure

The present disclosure determines the timing of an update process in a communication device, based on driving information of a vehicle, and thereby enables an update process without limiting the use of the vehicle for the convenience of the user.

### BRIEF DESCRIPTION OF DRAWINGS

FIG. 1 is a schematic diagram showing the configuration of an on-board update system according to the embodiment.

FIG. 2 is a block diagram showing the configuration of an ECU.

FIG. 3 is a schematic diagram illustrating an update process performed by the ECU.

FIG. 4 is a block diagram showing the configuration of a gateway.

FIG. 5 is a block diagram showing the configuration of a server device.

FIG. 6 is a schematic diagram illustrating a no-driving time estimation process and an update timing decision process performed by the server device.

FIG. 7 is a flowchart of a driving information collection/transmission process, showing process steps performed by the gateway.

FIG. 8 is a flowchart of an update program acquisition process, showing process steps performed by the gateway.

FIG. 9 is a flowchart of an update process, showing process steps performed by the gateway.

FIG. 10 is a flowchart of an update process, showing process steps performed by the gateway.

FIG. 11 is a flowchart of process steps performed by the server device.

FIG. 12 is a flowchart of process steps performed by the server device.

FIG. 13 is a flowchart of an update process, showing process steps performed by the ECU.

FIG. 14 is a block diagram showing the configuration of a gateway according to Modified Example.

### DETAILED DESCRIPTION OF PREFERRED EMBODIMENTS

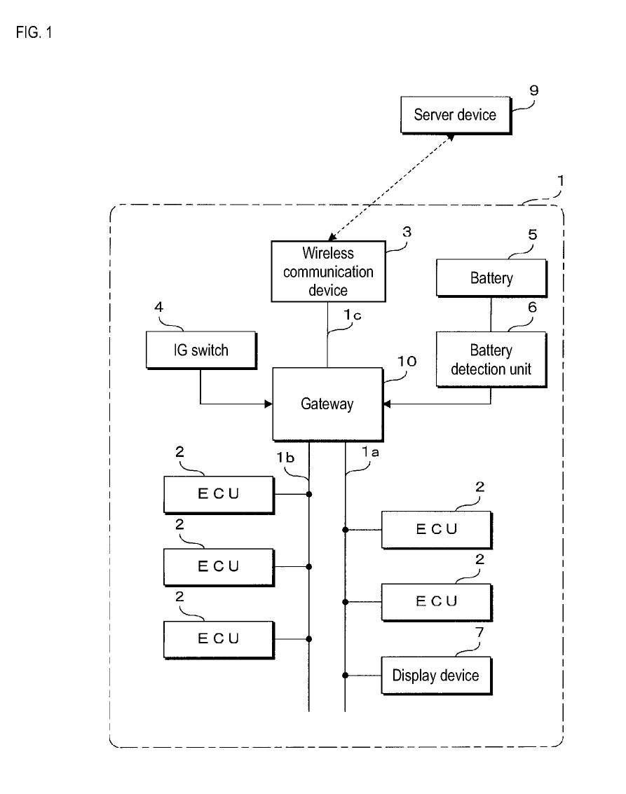

FIG. 1 is a schematic diagram showing the configuration of an on-board update system according to the embodiment. In the on-board update system according to this embodiment, a vehicle 1 is equipped with a plurality of ECUs (Electronic Control Units) 2, which communicate with each other via communication lines 1a, 1b and a gateway 10 arranged in the vehicle 1. In the on-board update system according to this embodiment, the gateway 10 corresponds to an on-board update device, and the ECUs 2 correspond to communication devices. In the system configuration of the illustrated example, two ECUs 2 and a display device 7 are connected to the in-vehicle communication line 1a, and three ECUs 2 are connected to the in-vehicle communication line 1b, with the two communication lines 1a, 1b being connected to the gateway 10. The gateway 10 relays communication between the communication lines 1a, 1b and thereby enables all ECUs 2 to transmit data to and receive data from the other ECUs 2 and the display device 7.

In the on-board update system according to this embodiment, a wireless communication device 3 is also connected to the gateway 10 via a communication line 1c. Via the wireless communication device 3, the gateway 10 can communicate with a server device 9 installed outside the vehicle 1. The gateway 10 further receives an IG signal from an IG switch 4 in the vehicle 1 and a detection result from a battery detection unit 6 that detects the amount of electric power charged in a battery 5 in the vehicle 1.

The ECUs 2 may include various kinds of ECUs such as an ECU that controls the engine operation of the vehicle 1, an ECU that controls locking/unlocking of the doors, an ECU that controls on/off of the lighting, an ECU that controls the airbag operation, and an ECU that controls the ABS (Antilock Brake System) operation. Each ECU 2 is connected to the communication line 1a or 1b arranged in the vehicle 1, and is capable of transmitting data to and receiving data from the other ECUs 2, the display device 7 and the gateway 10, via the communication lines 1a, 1b.

The wireless communication device 3 can transmit information to and receive information from the server device 9, for example, by wireless communication on a mobile telephone communication network, a wireless LAN (Local Area Network), or the like. The wireless communication device 3, which is connected to the gateway 10 via the communication line 1c, can transmit information to and receive information from the gateway 10 by wired communication. Thus, the wireless communication device 3 can relay the communication between the gateway 10 and the server device 9, by transmitting the data provided from the gateway 10 to the server device 9 and providing the data received from the server device 9 to the gateway 10.

The gateway 10 is connected with the communication lines 1a-1c that constitute an in-vehicle network for the vehicle 1, and relays data transmitted and received on these communication lines. In the example of FIG. 1, the gateway 10 is connected with three communication lines 1a-1c, namely, the first communication line 1a connected with two ECUs 2 and a display device 7, the second communication line 1b connected with three ECUs 2, and the third communication line 1c connected with the wireless communication device 3. The gateway 10 relays data by receiving data from any of the communication lines 1a-1c and transmitting the received data to the other communication lines 1a-1c.

The IG switch 4, which is a user-operated switch to start the engine of the vehicle 1 or to perform a like operation, changes over between two states, i.e., between on and off. In this embodiment, the IG signal indicates the state of the IG switch 4. When the IG signal indicates on, the motor of the vehicle 1 (e.g., an engine) is in operation, and an alternator or the like is generating power. When the IG signal indicates off, the motor of the vehicle 1 is not in operation, and an alternator or the like generates no power. The battery detection unit 6 detects the amount of electricity charged in the battery 5, for example, based on the voltage value at the output terminal of the battery 5 and/or the accumulated value of the input/output current at the battery 5. The display device 7 is, for example, a liquid crystal display or the like. On receiving a display command or the like from an ECU 2 or the gateway 10, the display device 7 shows a message or the like to the user of the vehicle 1. The display device 7 has an operation unit such as a touchscreen or hardware keys (not shown) for receiving the user's operation, and notifies the ECU 2 or the gateway 10 of the received operation. The display device 7 may be shared with, for example, a vehicle navigation system.

The server device 9 manages and stores the programs and data to be executed by the ECUs 2 installed in the vehicle 1. In response to an inquiry from the vehicle 1, the server device 9 informs the vehicle whether any program or the like needs updating. If an update is necessary, the server device 9 delivers an update program and data to the vehicle 1.

In the on-board update system according to the present embodiment, the gateway 10 and the server device 9 communicate with each other while the engine of the vehicle 1 is running. The gateway 10 acquires (downloads) a program and/or data, etc. required for an update, from the server device 9. After the engine of the vehicle 1 stops (after the IG switch 4 is turned off), the gateway 10 performs an update process at a predetermined update timing, by transmitting the program and/or data, etc. acquired from the server device 9, to the ECU 2 to be updated. The ECU 2 receives the program and/or data, etc. required for the update from the gateway 10, and performs the update process by writing the program and/or data, etc. in its own storage unit.

Further in the on-board update system according to the present embodiment, the gateway 10 collects driving information of the vehicle 1 and regularly transmits the information to the server device 9. The driving information transmitted from the gateway 10 to the server device 9 may contain, for example, an engine start-up time and engine stop time of the vehicle 1, a door locking/unlocking time of the vehicle 1, the user's seat occupation time of the vehicle 1, a seat belt fastening/unfastening time, a shifter operation time, a brake operation time, and the like. The gateway 10 collects such information from the on-board ECUs 2 or other on-board devices in the vehicle 1. In the present embodiment, the driving information contains the engine start-up time and the engine stop time in the vehicle 1.

The server device 9 receives driving information transmitted from the vehicle 1 and accumulates the received driving information in its storage unit. Based on the accumulated driving information, the server device 9 estimates a time slot when the vehicle 1 is highly unlikely to be driving. In the present embodiment, the time slot estimated by the server device 9 may be represented by a period defined by a start time and an end time (e.g., from 1:00 a.m. to 5:00 a.m.). More specifically, the estimated time slot may include additional conditions such as the day of the week or the date (e.g., from 1:00 a.m. to 5:00 a.m. on Sundays, or from 1:00 a.m. to 5:00 a.m. on the tenth day of every month). To estimate the time slot, the server device 9 refers to driving information for a predetermined period, for example, for the last 30 days, the last one year, or the like.

In the estimated time slot, the server device 9 determines a moment as the timing of an update process in one or more ECUs 2 in the vehicle 1. In this embodiment, the update timing determined by the server device 9 may be represented by the time of the day (e.g., 3:00 a.m.). At the determined update timing, the server device 9 transmits an update process start command to the vehicle 1. On receiving the start command, the gateway 10 of the vehicle 1 performs an update process by transmitting, to the target ECU 2, an update program and/or data that has been acquired from the server device 9 in advance and stored in the gateway 10. Alternatively, before the determined update timing, a start command that prescribes an update timing may be transmitted from the server device 9 to the vehicle 1. The gateway 10 of the vehicle 1 receives the start command that prescribes an update timing, and performs the update process in the target ECU 2 at the prescribed timing.

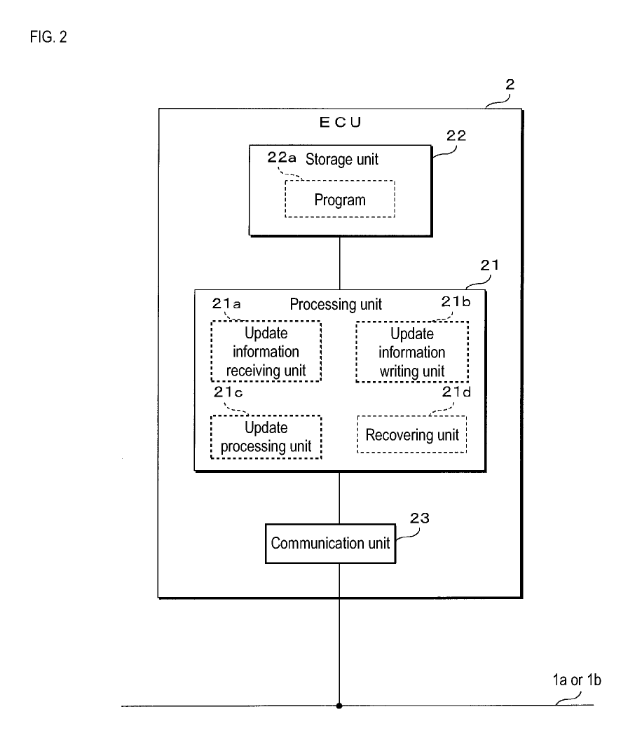

FIG. 2 is a block diagram showing the configuration of an ECU 2. This diagram focuses on the functional blocks common to the plurality of ECUs 2, and omits the functional blocks that are different in every ECU 2. Each of the ECUs 2 according to the present embodiment includes a processing unit 21, a storage unit 22, and a communication unit 23, for example. The processing unit 21 is constituted, for example, by an arithmetic processing unit such as a CPU (Central Processing Unit) or an MPU (Micro-Processing Unit). The processing unit 21 performs various arithmetic operations by retrieving and running a program 22a stored in the storage unit 22. The program 22a stored in the storage unit 22 is different in every ECU 2.

The storage unit 22 is configured with use of a non-volatile memory device such as a flash memory or EEPROM (Electrically Erasable Programmable Read Only Memory). The storage unit 22 stores not only the program 22a to be executed by the processing unit 21 but also data necessary for execution of the program 22a. Hereinafter, the term “program 22a” may encompass the program 22a and the data necessary for execution of the program 22a.

The communication unit 23 is connected with the communication line 1a or 1b that constitutes the in-vehicle network, and transmits and receives data pursuant to, for example, a communication protocol such as CAN (Controller Area Network). To transmit data, the communication unit 23 converts the data given from the processing unit 21 into an electric signal, and outputs the converted data signal to the communication line 1a or 1b. To receive data, the communication unit 23 samples an electrical potential at the communication line 1a or 1b, and then supplies the thus received data to the processing unit 21.

The processing unit 21 of the ECU 2 according to the present embodiment includes an update information receiving unit 21a, an update information writing unit 21b, an update processing unit 21c, and a recovering unit 21d. The update information receiving unit 21a to the recovering unit 21d are functional blocks for updating the program 22a stored in the storage unit 22. The update information receiving unit 21a to the recovering unit 21d are software-like functional blocks that are enabled when the processing unit 21 executes a program (illustration omitted) different from the program 22a to be updated.

The update information receiving unit 21a receives an update program transmitted from the gateway 10 via one of the communication lines, and accumulates the received update program in a buffer memory or the like (illustration omitted). The update program accumulated in the update information receiving unit 21a is written in the free space on the storage unit 22 by the update information writing unit 21b. After the update information writing unit 21b has finished writing the update program, the update processing unit 21c invalidates the pre-update program stored in the storage unit 22 and validates the newly written update program, thereby updating the program 22a. If the transmission of the update program from the gateway 10 is discontinued, the recovering unit 21d recovers the operation in the pre-update state by starting a process on the pre-update program stored in the storage unit 22.

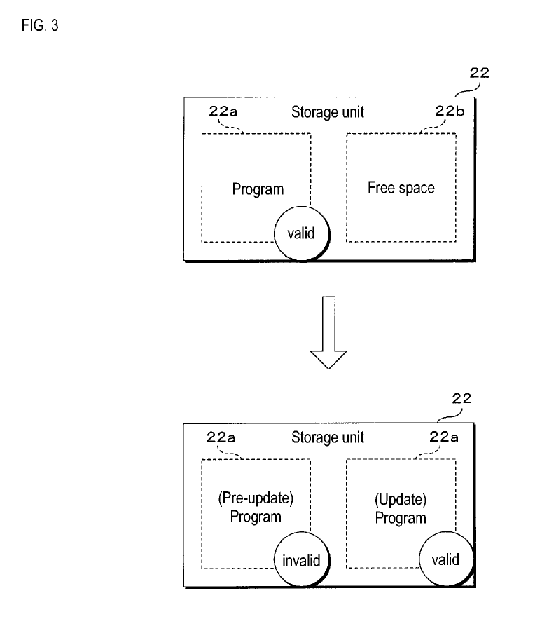

FIG. 3 is a schematic diagram illustrating an update process performed by the ECU 2. The storage unit 22 of the ECU 2 according to this embodiment has a storage capacity sufficient for at least two sets of the program 22a. In the example shown in the upper part of FIG. 3, the storage unit 22 includes a program 22a and free space 22b of substantially equal capacity. In this state, the program 22a stored in the storage unit 22 is valid, and the processing unit 21 retrieves and runs this program 22a.

When the update information receiving unit 21a receives an update program from the gateway 10, the update information writing unit 21b stores the received update program 22a in the free space 22b on the storage unit 22, instead of overwriting the pre-update program 22a. After the update information writing unit 21b has successfully written the update program 22a in the storage unit 22 without error, the update processing unit 21c invalidates the pre-update program 22a and validates the newly stored update program 22a, thereby completing the update process. Thereafter, the processing unit 21 in the ECU 2 retrieves and runs the validated update program 22a. The invalidated pre-update program 22a may be deleted, for example, at a suitable timing. Alternatively, the invalidated pre-update program 22a may be kept in the storage unit 22 without being deleted and, for example, may be regarded as free space 22b in the next update process.

In the ECU 2 according to this embodiment, the storage unit 22 at least includes an area for storing the pre-update program 22a (the first area) and an area for storing the update program 22a (the second area). Namely, the storage unit of each ECU 2 has a storage area that is capable of storing at least two sets of programs 22a. The ECU 2 receives the update program 22a transmitted for the update process from the gateway 10, and stores the received update program 22a in the area different from the one storing the pre-update program 22a. Thus, the ECU 2 stores the update program 22a in the storage unit 22 without overwriting the pre-update program 22a. After storing the update program 22a in the storage unit 22, each ECU 2 invalidates the pre-update program 22a and validates the update program 22a, thereby effecting a changeover in the program 22a to be executed by the processing unit 21. Namely, the ECU 2 completes the update process by a changeover in the program to be booted by the processing unit 21.

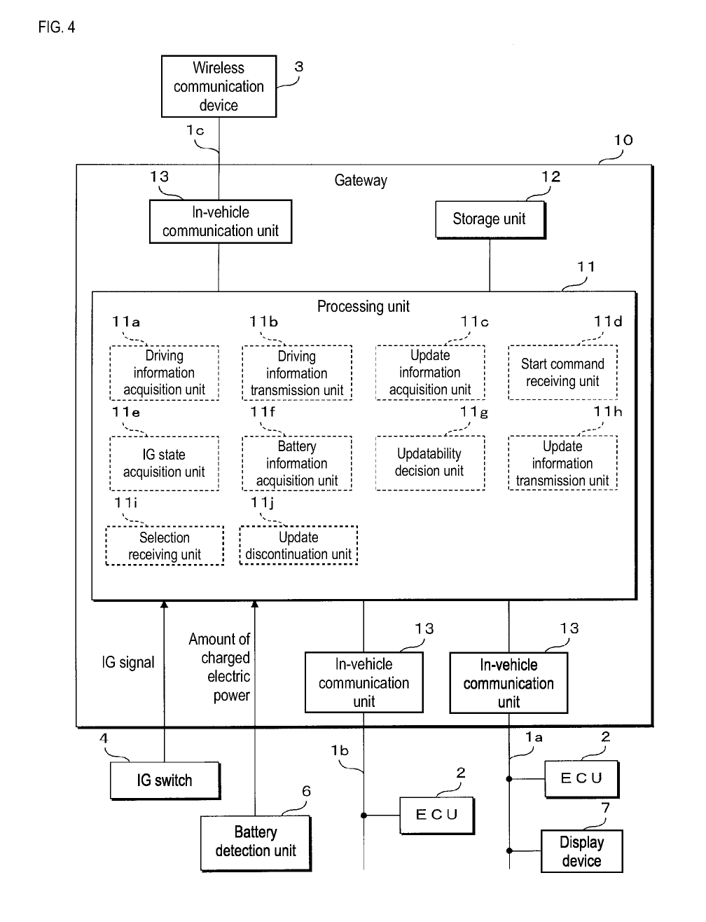

FIG. 4 is a block diagram showing the configuration of the gateway 10. The gateway 10 according to the present embodiment includes a processing unit 11, a storage unit 12, and three in-vehicle communication units 13, for example. The processing unit 11 is configured, for example, by an arithmetic processing unit such as a CPU or an MPU. The processing unit 11 performs various arithmetic operations by retrieving and running a program stored in the storage unit 12, ROM (Read Only Memory) (not shown), or the like. In the present embodiment, the processing unit 11 relays the data transmitted and received on the communication lines 1a-1c that constitute the in-vehicle network, and performs arithmetic operations necessary for the update processes of the ECUs 2 or for other purposes. The processing unit 11 also receives the IG signal from the IG switch 4 in the vehicle 1 and information about the amount of electric power charged in the battery from the battery detection unit 6. In this regard, in-vehicle communication through the communication lines 1a-1c may be also utilized to input the IG signal and/or the amount of electric power charged in the battery to the gateway 10.

The storage unit 12 is configured with use of a non-volatile memory device such as a flash memory or EEPROM. The storage unit 12 stores, for example, programs and data, etc. for updating the ECUs 2. The storage unit 12 may store the programs to be executed by the processing unit 11, data necessary for execution of the programs, and the like. The storage unit 12 may also store, for example, data generated during the processing in the processing unit 11.

The in-vehicle communication units 13 are connected one by one with the communication lines 1a-1c that constitute the in-vehicle network, and transmit and receive data pursuant to, for example, a communication protocol such as CAN. To transmit information, the in-vehicle communication units 13 convert the data given from the processing unit 11 into electric signals, and output the converted data signals to the communication lines 1a-1c. To receive data, the in-vehicle communication units 13 sample electrical potentials at the communication lines 1a-1c, and then supply the thus received data to the processing unit 11. The three in-vehicle communication units 13 provided in the gateway 10 may follow different communication protocols.

The processing unit 11 executes the programs stored in the storage unit 12, ROM, or the like, and thereby enables software-like functional blocks such as a driving information acquisition unit 11a, a driving information transmission unit 11b, an update information acquisition unit 11c, a start command receiving unit 11d, an IG state acquisition unit 11e, a battery information acquisition unit 11f, an updatability decision unit 11g, an update information transmission unit 11h, a selection receiving unit 11i, and an update discontinuation unit 11j.

The driving information acquisition unit 11a acquires driving information of the vehicle 1, from the information directly fed to the gateway 10 and the information received over the in-vehicle network. In the present embodiment, the driving information acquired by the driving information acquisition unit 11a is information about the engine start-up time and the engine stop time in the vehicle 1. The driving information acquisition unit 11a can acquire the information about the engine start-up time and the engine stop time by acquiring the time when, for example, the IG signal supplied from the IG switch 4 changes from off to on, or vice versa. To acquire the time information, the present embodiment utilizes a clock function provided in the processing unit 11. Alternatively, time information contained in a GPS (Global Positioning System) signal or the like may also be utilized. The driving information acquisition unit 11a stores the engine start-up time and the engine stop time in the storage unit 12 in the vehicle 1, the engine start-up time being the time when the IG signal changes from off to on, and the engine stop time being the time when the IG signal changes from on to off.

The driving information transmission unit 11b transmits the driving information acquired by the driving information acquisition unit 11a to the server device 9 via the wireless communication device 3. The transmission timing of the driving information by the driving information transmission unit 11b may be a prescribed cycle (e.g., every day or every week) or, for example, every time the driving information acquisition unit 11a acquires the driving information.

The update information acquisition unit 11c establishes communication with the server device 9 via the wireless communication device 3 at a predetermined timing, and asks whether the programs 22a in the ECUs 2 installed in the vehicle 1 need updating. The predetermined inquiry timing of the necessity of updates may be a prescribed cycle (e.g., every day or every week) or, for example, every time the IG switch 4 is turned from off to on. When informed by the server device 9 that one or more updates are necessary, the update information acquisition unit 11c acquires one or more programs, data, etc. necessary for the updates (hereinafter simply called as “update program(s)”) from the server device 9 via the wireless communication device 3, and stores the update programs in the storage unit 12. The update information acquisition unit 11c acquires update programs for all of the ECUs 2 that need updating.

The start command receiving unit 11d receives an update process start command transmitted from the server device 9 via the wireless communication device 3. If the server device 9 is configured to transmit a start command just at the timing to start the update process, the gateway 10 may start the update process when the start command receiving unit 11d receives the start command. If the server device 9 is configured to transmit a start command that prescribes a start timing before the timing to start of the update process, the start command receiving unit 11d stores the update timing in the storage unit 12 as prescribed by the received start command. In this case, the gateway 10 starts the update process at the prescribed update timing stored in the storage unit 12.

The IG state acquisition unit 11e monitors the on/off change of the IG switch 4, by acquiring an IG signal supplied from the IG switch 4 just at the timing to start the update process in the ECU 2 and during the update process. In the on-board update system according to the present embodiment, the update process is basically performed when the vehicle 1 is not driving, namely, when the IG switch 4 is off. Hence, even at the timing to start the update process, the update process is suspended if the IG switch 4 is on. If the IG switch 4 is turned from off to on during the update process, the update process is discontinued.

The battery information acquisition unit 11f acquires the amount of electric power charged in the battery 5 in the vehicle 1 when the update timing of the ECUs 2 has come, by acquiring the amount of charged electric power from the battery detection unit 6. If the battery detection unit 6 is configured to input the amount of electric power charged in the battery 5 to the gateway 10, the battery information acquisition unit 11f only needs to acquire the detection result from the battery detection unit 6. On the other hand, if the battery detection unit 6 is merely configured, for example, to input the terminal voltage value of the battery 5, the battery information acquisition unit 11f needs to acquire input information from the battery detection unit 6 and to calculate the amount of electric power charged in the battery 5 based on the acquired information.

The updatability decision unit 11g compares the amount of electric power charged in the battery 5 as acquired by the battery information acquisition unit 11f, with a predetermined threshold value. In accordance with the result of comparison, the updatability decision unit 11g decides whether one or more update processes using one or more corresponding update programs acquired from the server device 9 are executable. For example, suppose that an update process is permitted if the amount of electric power charged in the battery 5 is not less than 95%. In this case, the updatability decision unit 11g can decide whether the update process is executable, depending on whether the amount of charged electric power acquired by the battery information acquisition unit 11f is not less than 95%. If the updatability decision unit 11g decides that the update process is executable, the gateway 10 performs the update process. If not, the gateway 10 suspends the update process and waits for the next occasion.

The update information transmission unit 11h retrieves the update program that has been acquired by the update information acquisition unit 11c from the server device 9 and stored in the storage unit 22. The update information transmission unit 11h transmits the retrieved update program to the ECU 2 to be updated, thereby updating the program 22a stored in the storage unit 22 in the ECU 2. If more than one update program is decided to be executable, the update information transmission unit 11h may transmit the update programs sequentially in proper order, or all at once in parallel. The update program transmitted to the ECU 2 by the update information transmission unit 11h is deleted from the storage unit 12 (or may be kept, instead of being deleted, until other data need to be written). On the other hand, the update program to be suspended by the decision of the updatability decision unit 11g is kept in the storage unit 12 and waits for the next chance of an update process.

If the updatability decision unit 11g decides that the update process is not executable, the update process is suspended. Later, when the IG switch 4 is turned from off to on, the selection receiving unit 11i receives the user's selection that authorizes or suspends the update process. At this time, the selection receiving unit 11i instructs the display device 7 via the in-vehicle communication unit 13 to present a message to the user. On receiving this instruction, the display device 7 presents a message, for example, “The software update has been suspended due to a low battery. Do you want to start the update now? This update requires about five minutes. The car will be unavailable while the update is in progress.” The display device 7 has an operation unit such as a touchscreen or hardware keys for receiving the user's selection that authorizes or suspends the update process, and transmits the received selection to the gateway 10. Based on the information from the display device 7, the selection receiving unit 11i in the gateway 10 receives the user's selection that authorizes or suspends the update process. If the selection receiving unit 11i receives a selection that authorizes the update process, the gateway 10 performs the update process in the ECU 2. If the selection receiving unit 11i receives a selection that suspends the update process, the gateway 10 suspends the update process and waits for the next occasion.

After the update process has started at the update timing, the state of the IG switch 4 acquired by the IG state acquisition unit 11e may change, in some cases, from off to on while the update process is in progress. If this happens, the update discontinuation unit 11j discontinues the update process. Specifically, the update discontinuation unit 11j discontinues the update process of the program 22a in the ECU 2 by discontinuing the transmission of the update program to the ECU 2 by the update information transmission unit 11h. At this time, the update discontinuation unit 11j may also notify the ECU 2 that the update process is discontinued. Following the discontinuation of the update process, the recovering unit 21d causes the ECU 2 to recover the operation on the pre-update program 22a.

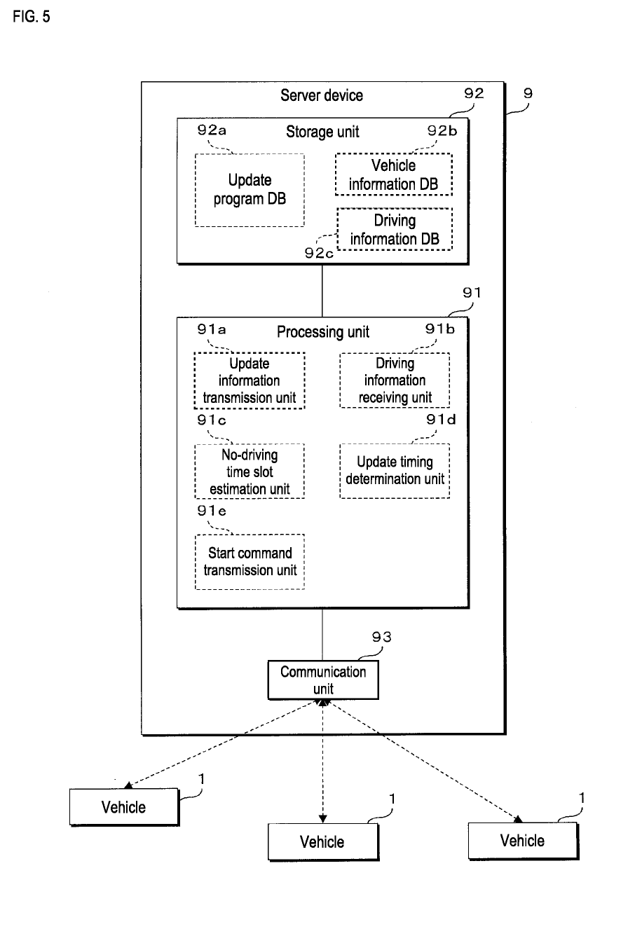

FIG. 5 is a block diagram showing the configuration of the server device 9. The server device 9 according to the present embodiment is administered, for example, by a manufacturer, a dealer, or others relevant to the vehicle 1, and is installed on a suitable site outside the vehicle 1. The server device 9, which can communicate with a plurality of vehicles 1, collects and manages information of these vehicles 1. The server device 9 is composed of a processing unit 91, a storage unit 92, a communication unit 93, and the like. The processing unit 91 is configured, for example, by an arithmetic processing unit such as a CPU or an MPU, and performs various arithmetic operations for maintenance of the vehicles 1 by retrieving and running a server program stored in the storage unit 92. The processing unit 91 in the present embodiment performs a process for distributing update programs for on-board ECUs 2 in the vehicles 1, a process for determining the timing of update processes using the update programs, and other like processes.

The storage unit 92 is constituted, for example, by a mass storage device such as a hard disk. The storage unit 92 not only stores a server program to be executed by the processing unit 91 and data necessary for execution of the program, but also stores data generated during the processing in the processing unit 91. In the present embodiment, the storage unit 92 includes an update program DB (database) 92a that stores update programs or data to be distributed to the vehicles 1. The update programs stored in the update program DB 92a include different versions of programs for diverse on-board ECUs 2 that can be installed in various types of vehicles 1. The server device 9 selects a suitable program from these update programs and transmits the selected program to a vehicle 1.

The storage unit 92 also includes a vehicle information DB 92b that stores information of the vehicles 1. The vehicle information DB 92b stores, for example, types and models of vehicles 1, types of on-board ECUs 2, software versions on the ECUs 2, and other like information. Based on the vehicle information DB 92b, the server device 9 can decide whether the ECUs 2 in each vehicle 1 need updating. The storage unit 92 further includes a driving information DB 92c that stores driving information received from the gateways 10 of the vehicles 1.

The communication unit 93 communicates with the vehicles 1, for example, over the Internet, the mobile telephone communication network, and the like. The communication unit 93 receives a message for transmission from the processing unit 91 and transmits this message to an intended vehicle 1. The communication unit 93 receives a message from each vehicle 1 and provides this message to the processing unit 91.

The processing unit 91 executes the server program stored in the storage unit 92, and thereby enables software-like functional blocks such as an update information transmission unit 91a, a driving information receiving unit 91b, a no-driving time slot estimation unit 91c, an update timing determination unit 91d, and a start command transmission unit 91e. When receiving an inquiry about the necessity of an update from the gateway 10 of a vehicle 1, the update information transmission unit 91a acquires information about this vehicle 1 from the vehicle information DB 92b, decides whether this vehicle 1 needs any program update, and returns the decision result to the vehicle 1 as a reply to the inquiry. When receiving an update program transmission request from the gateway 10 of a vehicle 1, the update information transmission unit 91a retrieves an update program suitable for the requestor vehicle 1 from the update program DB 92a of the storage unit 92, and transmits the retrieved program to the requestor vehicle 1.

The driving information receiving unit 91b receives driving information of the vehicle 1 that is transmitted from the gateway 10 of each vehicle 1 periodically or at a suitable timing. When receiving the driving information from the vehicle 1, the driving information receiving unit 91b associates the received driving information with the identification information or other information of this vehicle 1, and stores the information in the driving information DB 92c of the storage unit 92.

The no-driving time slot estimation unit 91c estimates a time slot (or slots) when the vehicle 1 is highly unlikely to be driving, based on the driving information of each vehicle 1 transmitted from the vehicle 1 and accumulated in the driving information DB 92c of the storage unit 92. In the time slot estimated by the no-driving time slot estimation unit 91c, the update timing determination unit 91d determines a specific timing as the update timing for the vehicle 1.

The start command transmission unit 91e transmits an update process start command to each vehicle 1, based on the update timing determined by the update timing determination unit 91d. The start command transmission unit 91e may be configured to transmit a start command to a vehicle 1, just at the timing determined by the update timing determination unit 91d. In this case, the vehicle 1 that has received the start command starts the update process instantly. Alternatively, the start command transmission unit 91e may be configured to transmit a start command that prescribes an update timing, to the vehicle 1 before the timing determined by the update timing determination unit 91d. In this case, the vehicle 1 that has received the start command does not start the update process immediately. Instead, the gateway 10 of the vehicle 1 starts the update process in the vehicle 1 at the update timing prescribed by the start command.

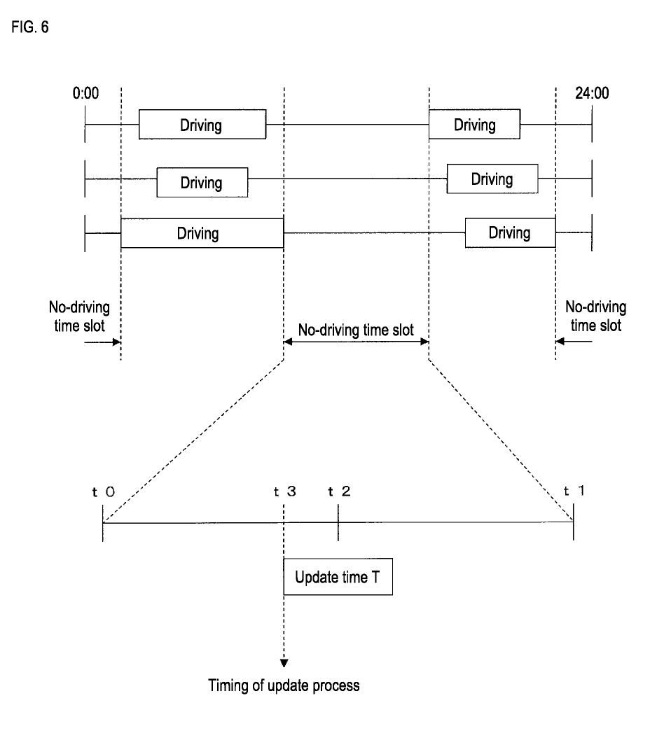

FIG. 6 is a schematic diagram illustrating a no-driving time estimation process and an update timing decision process performed by the server device 9.

The upper part of FIG. 6 shows an example of three-day driving information of a vehicle 1, aligned vertically, accumulated in the driving information DB 92c of the storage unit 92 in the server device 9. As the driving information from 0:00 to 24:00 in each day, the period when the vehicle 1 was driving (when the IG switch 4 was on) is represented by a horizontal rectangle labelled “Driving”, and the period when the vehicle 1 was not driving (when the IG switch 4 was off) is represented by a horizontal solid line. For simplicity, the no-driving time slot in this example is estimated from three-day driving information. Actually, the no-driving time slot may be estimated from a greater volume of driving information, for example, for one month, six months, etc.

From the three-day driving information, the no-driving time slot estimation unit 91c in the server device 9 extracts one or more time slots when the vehicle 1 was not driving at all. In this example, the no-driving time slot estimation unit 91c extracts two time slots, namely, a time slot around the middle of the day and a time slot from the end of a day to the start of the next day. If only one time slot is extracted, the no-driving time slot estimation unit 91c may take this extracted time slot as the no-driving time slot. If more than one time slot is extracted, the no-driving time slot estimation unit 91c selects the longest time slot as the no-driving time slot. In this example, the time slot around the middle of the day is taken as the estimation result of the no-driving time slot.

The update timing determination unit 91d in the server device 9 calculates the middle time of the no-driving time slot, t2=(t0+t1)/2, based on the start time t0 and the end time t1 of the no-driving time slot estimated by the no-driving time slot estimation unit 91c. The update timing determination unit 91d also estimates the time T required for an update process in the vehicle 1. The time T required for the update process may be estimated, for example, on the basis of the data size of an update program. The update timing determination unit 91d determines an update start time t3 such that the update time can include the middle time t2 of the no-driving time slot. In this example, the update start time t3 is calculated as t3=t2−T/2.

The start command transmission unit 91e in the server device 9 transmits, to the vehicle 1, an update start command to the vehicle 1, just at the update start time t3 determined by the update timing determination unit 91d, or an update start command that prescribes the update start time t3, in a period after the determination of the update timing by the update timing determination unit 91d and before the update start time t3.

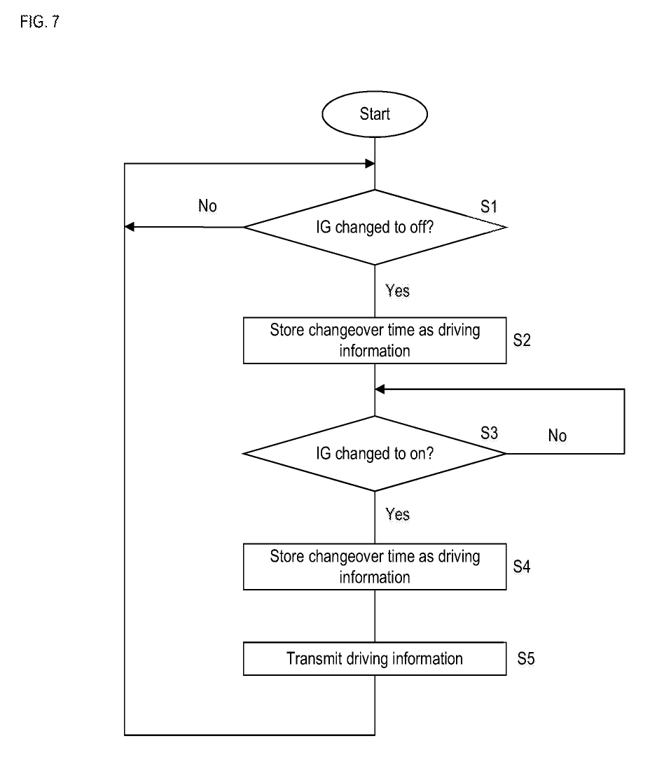

FIG. 7 is a flowchart of a driving information collection/transmission process, showing process steps performed by the gateway 10. In the initial state of the process shown in this flowchart, the IG switch 4 in the vehicle 1 is on. In the gateway 10, the driving information acquisition unit 11a of the processing unit 11 acquires an IG signal supplied from the IG switch 4, and decides whether the IG signal has changed from on to off (Step S1). If the IG signal has not changed to off (NO in Step S1), the driving information acquisition unit 11a waits until the IG signal changes to off. If the IG signal has changed to off (YES in Step S1), the driving information acquisition unit 11a acquires the changeover time of the IG signal and stores the changeover time in the storage unit 12 as driving information (Step S2).

Next, the driving information acquisition unit 11a decides whether the

IG signal has changed from off to on (Step S3). If the IG signal has not changed to on (NO in Step S3), the driving information acquisition unit 11a waits until the IG signal changes to on. If the IG signal has changed to on (YES in Step S3), the driving information acquisition unit 11a acquires the changeover time of the IG signal and stores the changeover time in the storage unit 12 as driving information (Step S4). The driving information transmission unit 11b transmits the driving information stored in the storage unit 12 to the server device 9 via the wireless communication device 3 (Step S5). Then, the process returns to Step S1.

In the flowchart shown in FIG. 7, the driving information is transmitted to the server device 9 when the IG switch 4 is turned on. However, the driving information may also be transmitted at a different timing.

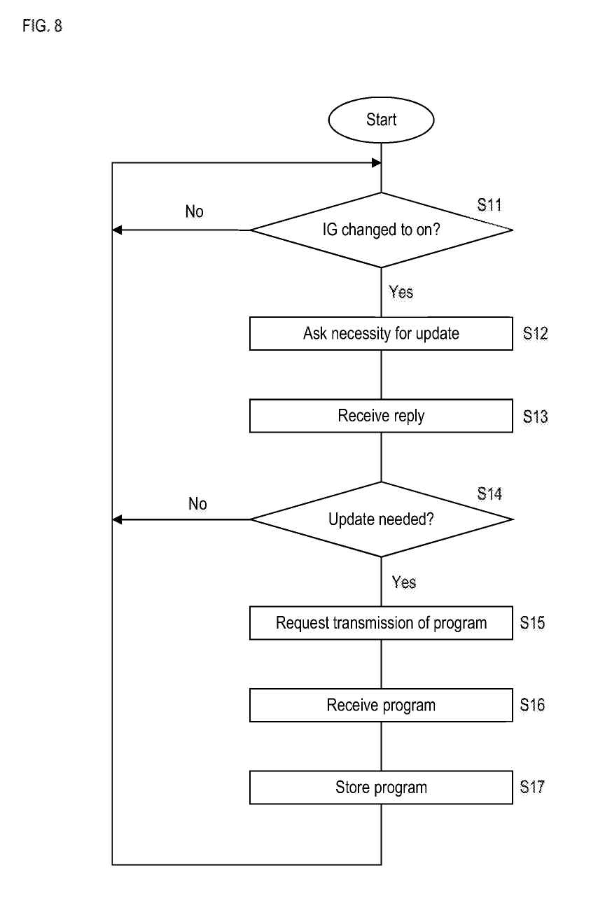

FIG. 8 is a flowchart of an update program acquisition process, showing process steps performed by the gateway 10. In the gateway 10, the update information acquisition unit 11c of the processing unit 11 acquires an IG signal supplied from the IG switch 4 and decides whether the IG signal has changed from off to on (Step S11). If the IG signal has not changed to on (NO in Step S11), the update information acquisition unit 11c waits until the IG signal changes to on. If the IG signal has changed to on (YES in Step S11), the update information acquisition unit 11c establishes wireless communication with the server device 9 via the wireless communication device 3, and asks whether any of the on-board ECUs 2 in the vehicle 1 needs to update a program (Step S12).

When the server device 9 transmits a reply to this inquiry, the update information acquisition unit 11c receives the reply via the wireless communication device 3 (Step S13). This reply contains not only information about the necessity of an update, but also information about a program that needs to be updated (e.g., program identification information, and other information about the program such as amount of data). Based on the reply from the server device 9, the update information acquisition unit 11c decides whether any of the on-board ECUs 2 in the vehicle 1 needs to update a program (Step S14). If an update is not necessary (NO in Step S14), the process of the update information acquisition unit 11c returns to Step S11. If an update is necessary (YES in Step S14), the update information acquisition unit 11c requests the server device 9 to transmit the update program (Step S15). When the server device 9 transmits the update program in response to this request, the update information acquisition unit 11c receives the update program via the wireless communication device 3 (Step S16). The update information acquisition unit 11c stores the received update program in the storage unit 12 (Step S17). Then, the process of the update information acquisition unit 11c returns to Step S11.

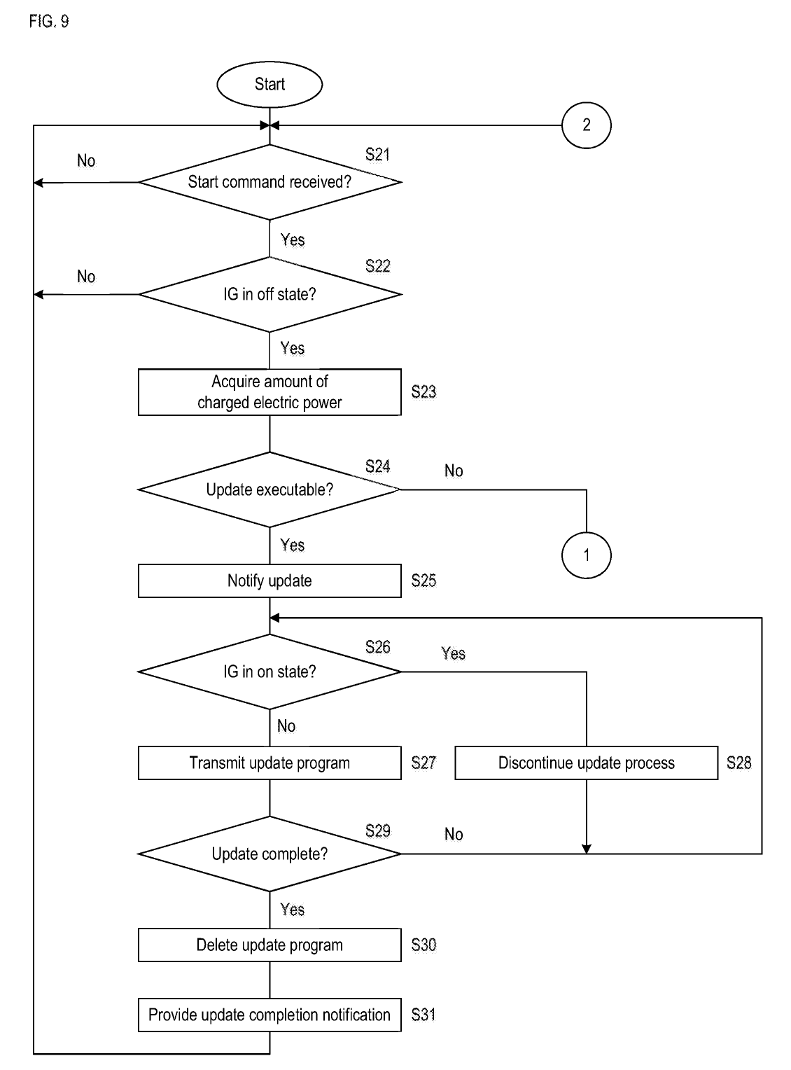

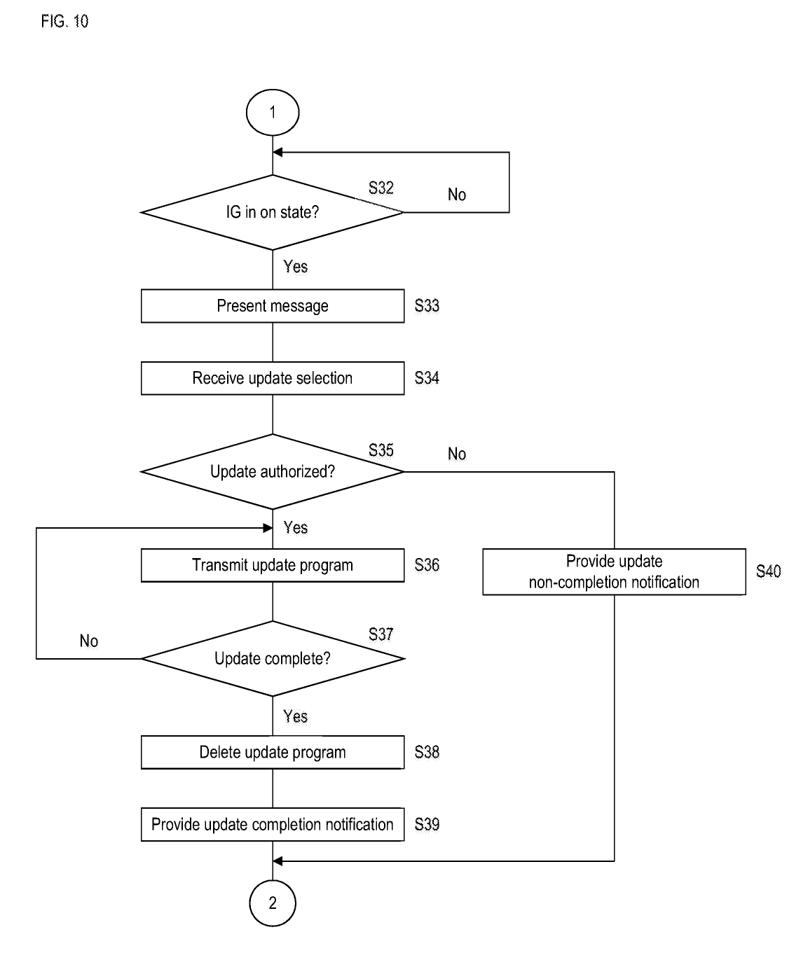

FIGS. 9 and 10 are flowcharts of an update process, showing process steps performed by the gateway 10. In the gateway 10, the start command receiving unit 11d of the processing unit 11 decides whether it has received an update process start command transmitted from the server device 9 via the wireless communication device 3 (Step S21). If an update process start command has not been received (NO in Step S21), the start command receiving unit 11d waits until it receives a start command from the server device 9. If an update process start command has been received (YES in Step S21), the IG state acquisition unit 11e of the processing unit 11 acquires the IG signal supplied from the IG switch 4 and decides whether the IG signal is off (Step S22). If the IG signal is on (NO in Step S22), the IG state acquisition unit 11e returns the process to Step S21. At this time, the gateway 10 may notify the server device 9 that an update process has not been done.

If the IG signal is off (YES in Step S22), the battery information acquisition unit 11f of the processing unit 11 acquires the amount of electric power charged in the battery 5 from the battery detection unit 6 (Step S23). The updatability decision unit 11g of the processing unit 11 decides whether an update process is executable, based on whether the amount of electric power charged in the battery 5 acquired in Step S23 is greater than a predetermined threshold value (Step S24). If the update process is executable (YES in Step S24), the processing unit 11 notifies the target ECU 2, via the in-vehicle communication unit 13, that an update process is going to be performed (Step S25).

Then, the IG state acquisition unit 11e of the processing unit 11 acquires an IG signal supplied from the IG switch 4 and decides whether the IG signal is on (Step S26). If the IG signal is not on (NO in Step S26), the update information transmission unit 11h of the processing unit 11 retrieves the stored update program from the storage unit 12 and transmits the update program to the ECU 2 to be updated (Step S27). In this step, the update information transmission unit 11h divides the update program stored in the storage unit 12 in a predetermined data size, and sequentially transmits divided pieces of the update program to the ECU 2. The update information transmission unit 11h checks whether the update program stored in the storage unit 12 has been completely transmitted to the ECU 2, and thereby decides whether the update process in the ECU 2 is complete (Step S29). If the update process is not complete (NO in Step S29), the processing unit 11 returns the process to Step S26.

If the IG signal is in the on state in Step S26 (YES in Step S26), the update discontinuation unit 11j of the processing unit 11 discontinues the transmission of the update program by the update information transmission unit 11h, and notifies the ECU 2 that the update process is discontinued (Step S28). Later, if the IG signal has changed to off, which removes the cause of the discontinuation of the update process, the update discontinuation unit 11j re-transmits a notification that the update process is going to be performed, to the ECU 2 in which the update process has been discontinued. Then, the process returns to Step S26. The processing unit 11 continues to transmit the update program to the ECU 2, by transmitting the update program to the ECU 2 and, if necessary, discontinuing the transmission. If the update process is complete (YES in Step S29), the processing unit 11 deletes the used update program from the storage unit 12 (Step S30). The processing unit 11 notifies the server device 9 of completion of the update via the wireless communication device 3 (Step S31). Then, the process returns to Step S21.

If the updatability decision unit 11g decides in Step S24 that the update process is not executable, based on the amount of electric power charged in the battery 5 (NO in Step S24), the IG state acquisition unit 11e of the processing unit 11 acquires an IG signal supplied from the IG switch 4 and decides whether the IG signal is on (Step S32). If the IG signal is not on (NO in Step S32), the processing unit 11 waits until the IG signal changes to on. If the IG signal is on (YES in Step S32), the selection receiving unit 11i of the processing unit 11 transmits a message display command to the display device 7 via the in-vehicle communication unit 13, thereby causing the display device 7 to present a message for promoting a selection that authorizes or suspends the update process (Step S33). From the display device 7, the selection receiving unit 11i receives operations at the operation unit of the display device 7, and thus receives a selection operation of whether to authorize or suspend the update process (Step S34).

Based on the selection received by the selection receiving unit 11i, the processing unit 11 decides whether the update process is authorized (Step S35). If the update process is authorized (YES in Step S35), the update information transmission unit 11h of the processing unit 11 retrieves the stored update program from the storage unit 12 and transmits the update program to the ECU 2 to be updated (Step S36). The update information transmission unit 11h checks whether the update program stored in the storage unit 12 has been completely transmitted to the ECU 2, and thereby decides whether the update process in the ECU 2 is complete (Step S37). If the update process is not complete (NO in Step S37), the processing unit 11 returns the process to Step S36. If the update process is complete (YES in Step S37), the processing unit 11 deletes the used update program from the storage unit 12 (Step S38). The processing unit 11 notifies the server device 9 of completion of the update via the wireless communication device 3 (Step S39). Then, the process returns to Step S21.

If the update process is not authorized (NO in Step S35), the processing unit 11 provides a notification that the update process is not complete, via the wireless communication device 3 to the server device 9 (Step S40). Then, the process returns to Step S21.

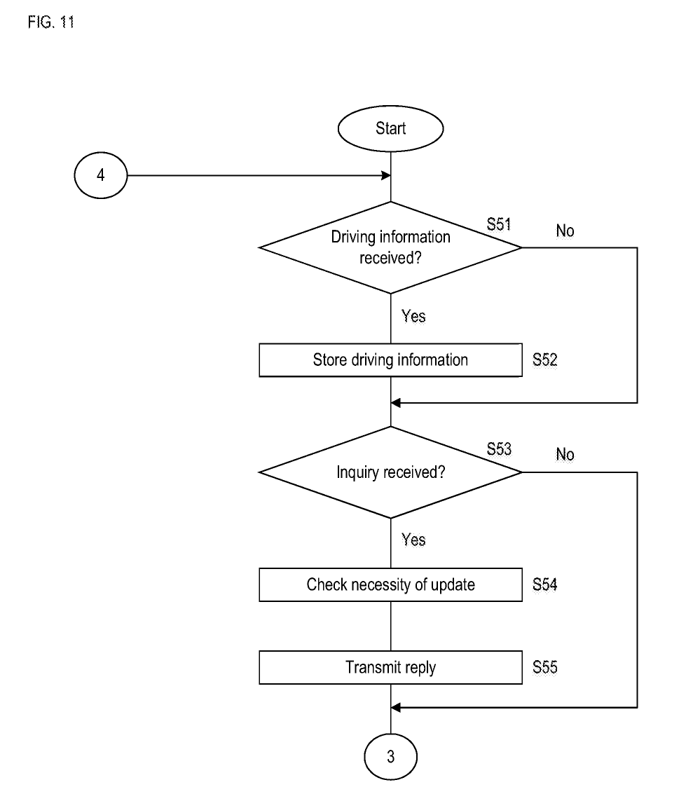

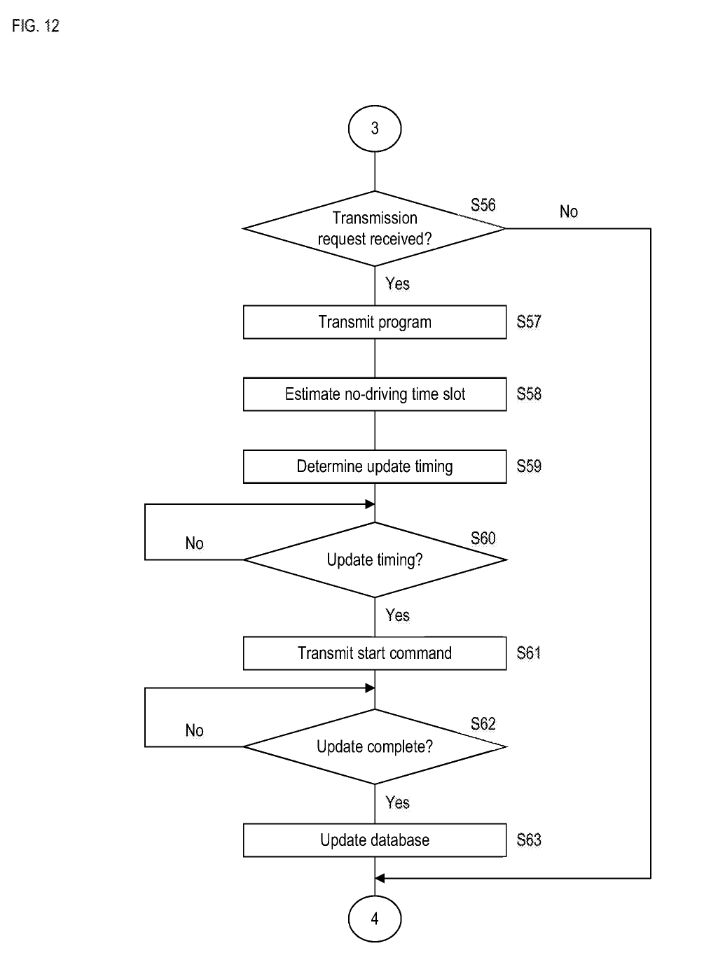

FIGS. 11 and 12 are flowcharts of process steps performed by the server device 9. The server device 9, which manages a plurality of vehicles 1, performs the process shown in these flowcharts separately for each vehicle 1. In the server device 9, the driving information receiving unit 91b of the processing unit 91 decides whether it has received driving information transmitted from the vehicle 1 (Step S51). If the driving information receiving unit 91b has not received driving information (NO in Step S51), the process goes to Step S53. If the driving information receiving unit 91b has received driving information (YES in Step S51), the driving information is stored in the driving information DB 92c of the storage unit 92 (Step S52), and the process goes to Step S53.

Then, the processing unit 91 decides whether it has received an inquiry from the vehicle 1 about the necessity of any program update in the ECUs 2 (Step S53). If no inquiry is received (NO in Step S53), the process of the processing unit 91 goes to Step S56. If an inquiry is received (YES in Step S53), the processing unit 91 refers to the vehicle information DB 92b of the storage unit 92, and checks the necessity of a program update for each ECU 2 in the inquiry-making vehicle 1 (Step S54). As a reply, the processing unit 91 transmits the check result of the necessity of any update to the inquiry-making vehicle 1 (Step S55). Then, the process of the processing unit 91 goes to Step S56.

Next, the processing unit 91 decides whether it has received an update program transmission request from the vehicle 1 (Step S56). If no transmission request is received (NO in Step S56), the process of the processing unit 91 returns to Step S51. If a transmission request is received (YES in Step S56), the update information transmission unit 91a of the processing unit 91 retrieves an update program for an ECU 2 in the requestor vehicle 1, from the update program DB 92a of the storage unit 92, and transmits the retrieved update program to the requestor vehicle 1 (Step S57). Based on the driving information stored in the driving information DB 92c, the no-driving time slot estimation unit 91c of the processing unit 91 estimates the no-driving time slot (the time slot when the vehicle is highly unlikely to be driving) for the vehicle 1 to which the update program has been transmitted (Step S58). Based on the no-driving time slot estimated by the no-driving time slot estimation unit 91c, the update timing determination unit 91d of the processing unit 91 determines the timing of the update process (Step S59).

The processing unit 91 decides whether the determined update timing has come, by comparing the time measured by its own clock function with the time of the update timing determined in Step S59 (Step S60). If it is not yet the update timing (NO in Step S60), the processing unit 91 waits until the update timing comes. If the update timing has come (YES in Step S60), the start command transmission unit 91e of the processing unit 91 transmits a start command to the vehicle 1 to which the update program has been transmitted (Step S61).

Thereafter, the processing unit 91 checks whether it has received a notification of completion of the update process from the vehicle 1, and thereby decides whether the update process is complete (Step S62). If the update process is not complete (NO in Step S62), the processing unit 91 waits until the update process is complete. If the update process is complete (YES in Step S62), the processing unit 91 updates the vehicle information DB 92b of the storage unit 92 to record that the program update is complete (Step S63). Then, the process returns to Step S51. Although not shown in this flowchart, when the processing unit 91 receives a notification from the vehicle 1 that the update process is not complete, the process may return to the Step S58. In this case, the processing unit 91 may estimate a new no-driving time slot, determine a new update timing, and perform other processes again in the same manner.

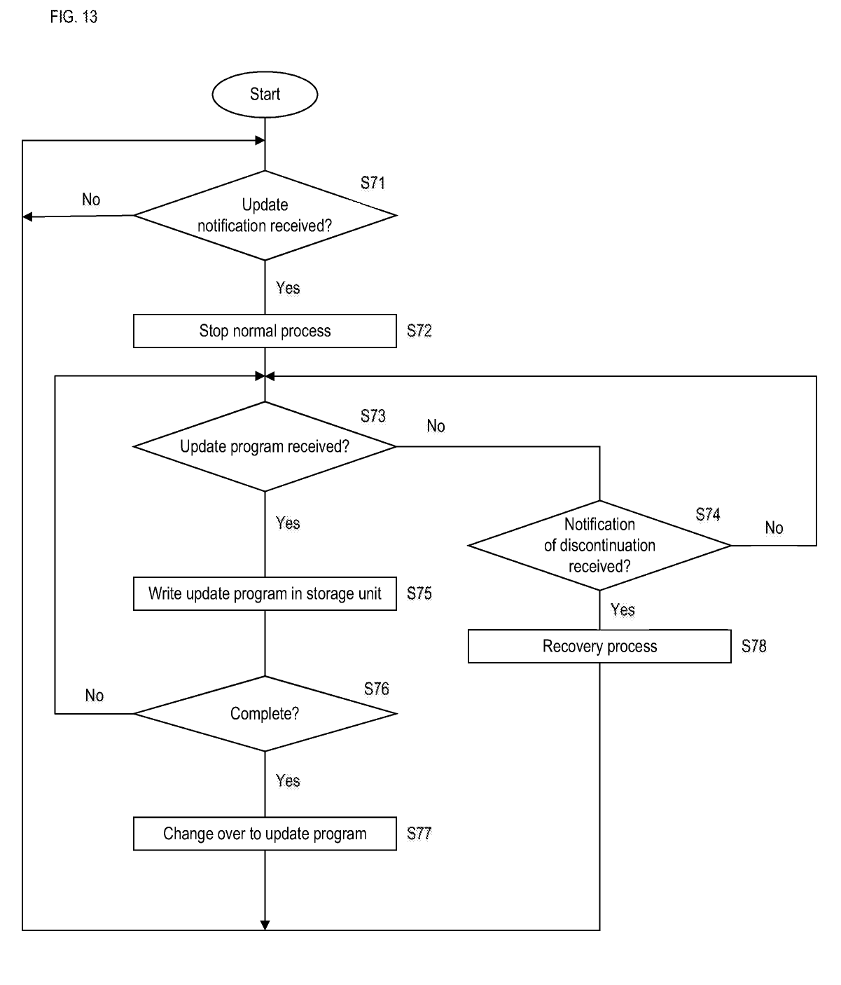

FIG. 13 is a flowchart of an update process, showing process steps performed by the ECU 2. The processing unit 21 in the ECU 2 decides whether it has received a notification from the gateway 10 that an update process of the program 22a stored in the storage unit 22 is going to be performed (Step S71). If such a notice has not been received (NO in Step S71), the processing unit 21 waits until it receives a notification of an update process. If a notification of an update process has been received (YES in Step S71), the processing unit 21 stops the usual process using the program 22a stored in the storage unit 22 (Step S72), and switches from a normal operation mode to an update process mode.

The update information receiving unit 21a of the processing unit 21 decides whether it has received the update program (pieces of the update program divided in a predetermined data size) transmitted from the gateway 10 (Step S73). If the update program has been received (YES in Step S73), the update information writing unit 21b of the processing unit 21 writes the received update program in the free space 22b on the storage unit 22 (Step S75). Then, the processing unit 21 decides whether the whole update program have been received from the gateway 10 and written in completely (Step S76). If the whole update program has not been written in (NO in Step S76), the processing unit 21 returns the process to Step S73. If the whole update program has been written in (YES in Step S76), the update processing unit 21c of the processing unit 21 invalidates the pre-update program 22a stored in the storage unit 22 and validates the newly stored update program 22a, thereby effecting a changeover in the program 22a to be executed by the processing unit 21 (Step S77). Then, the process returns to Step S71. In this manner, the ECU 2 switches from the update process mode to the normal operation mode using the updated program 22a.

If the update program has not been received from the gateway 10 (NO in Step S73), the processing unit 21 decides whether it has received a notification of a discontinued update process (Step S74). If the processing unit 21 has not received a notification of a discontinued update process (NO in Step S74), the processing unit 21 returns the process to Step S73 and waits until it receives an update program or a notification of a discontinued update process from the gateway 10. If the processing unit 21 has received a notification of a discontinued update process (YES in Step S74), the recovering unit 21d of the processing unit 21 stops receiving and writing the update program, and recovers the operation using the pre-update program 22a stored in the storage unit 22 (Step S78). Then, the process returns to Step S71. In this manner, the ECU 2 switches from the update process mode to the normal operation mode by the pre-update program 22a.

In the thus configured on-board update system according to this embodiment, the gateway 10 performs an update process of the program 22a stored in the storage unit 22 of each ECU 2 installed in the vehicle 1. The gateway 10 acquires the update program from the server device 9 installed outside the vehicle 1. If more than one ECU 2 needs updating, the gateway 10 acquires an update program for each ECU 2. Alternatively, the on-board update system may apply one update program to the update process of more than one ECU 2. The gateway 10 transmits, at a predetermined timing, the update program acquired from the server device, to the ECU 2 to be updated. The ECU 2 that has received the update program from the gateway 10 updates its program 22a by writing the received update program in the storage unit 22. The timing when the gateway 10 acquires an update program from the server device 9 and the timing when the gateway 10 transmits the update program to the ECU 2 may not necessarily be the same. For example, the gateway 10 may acquire an update program from the server device 9 and may store the acquired update program in the storage unit 12 while the vehicle 1 is driving. After the vehicle 1 is parked and the engine has stopped, the gateway 10 may transmit the stored update program to the ECU 2 to be updated.

In the on-board update system according to the present embodiment, the server device 9 determines the timing when the gateway 10 transmits an update program to the ECU 2 to be updated, namely, the timing of the update process in the target ECU 2. For this purpose, the gateway 10 acquires and transmits driving information of the vehicle 1 to the server device 9. Based on the driving information received from the gateway 10, the server device 9 determines the timing of the update process and transmits an update process start command to the gateway 10. The gateway 10 receives the start command from the server device 9, starts to transmit the update program to the ECU 2 in accordance with the received start command, and thus starts the update process in the ECU 2.

The server device 9 that has determined the timing of the update process may be configured to transmit a start command to the gateway 10 just at the determined timing, and to cause the gateway 10 to start the update process in the ECU 2, immediately or without delay, when the gateway 10 receives the start command. Alternatively, the server device 9 that has determined the timing of the update process may be configured to transmit a start command that prescribes the time of the update process or the like, to the gateway 10 before the prescribed time, and to cause the gateway 10 to start the update process at the prescribed time after the gateway 10 has received the start command. In this case, when the server device 9 transmits an update program to the gateway 10, the server device 9 may transmit the start command that prescribes the timing of the update process together with the update program.

In the thus configured on-board update system according to the present embodiment, the server device 9 can accumulate driving information of the vehicle 1, can determine a suitable update timing for the ECU 2 (e.g., the time slot when the vehicle 1 is highly unlikely to be driving), can transmit a start command to the gateway 10, and can cause the gateway 10 to update the ECU 2 at the determined timing. This on-board update system, which determines the timing of the update process in the ECU 2 based on the driving information of the vehicle 1, can perform an update process without limiting the use of the vehicle 1 for the convenience of the user.

In the present embodiment, the server device 9, which receives information from the gateway 10, stores and accumulates the received information in the driving information DB 92c of the storage unit 92. The server device 9 refers to the accumulated driving information and estimates the time slot when the vehicle 1 is not driving. For example, the server device 9 refers to the accumulated driving information for a predetermined number of days (e.g., one-month or the like) and extracts, from this period, one or more time slots when the vehicle 1 was not driving. If only one time slot is extracted, the server device 9 may take this time slot as the time slot when the vehicle is not driving. If more than one time slot is extracted, the server device 9 selects the longest time slot as the time slot when the vehicle is not driving. Then, the server device 9 calculates the middle time of the estimated time slot and determines the timing of an update process in a predetermined time range around this middle time. The predetermined time range may be, for example, the time required for the update process in the ECU 2. Owing to these arrangements, the server device 9 can transmit an update process start command to the gateway 10 such that the update process can be performed in the time slot when the vehicle 1 is highly unlikely to be driving.

Further in the present embodiment, the gateway 10 acquires information about the amount of electric power charged in the battery 5 in the vehicle 1. Prior to the update process, the gateway 10 decides whether the update process is executable in accordance with the amount of electric power charged in the battery 5. The gateway 10 decides whether the update process is executable, for example, depending on whether the amount of electric power charged in the battery 5 is greater than a predetermined threshold value. If the gateway 10 decides that an update process is executable based on the amount of electric power charged in the battery 5, the gateway 10 starts to transmit the update program to the ECU 2. This arrangement can prevent, for example, a loss of battery power or similar troubles during the update process.

Further in the present embodiment, the gateway 10 acquires the state of the IG signal produced by the IG switch in the vehicle 1. If the gateway 10 decides that an update process is not executable in accordance with the amount of electric power charged in the battery 5, the update process is suspended. Later, when the IG signal changes from off to on, the gateway 10 tries the suspended update process. In this case, however, the change of the IG signal to the on state possibly means that the user may intend to drive the vehicle 1. Once the update process has started, the vehicle 1 is unavailable until the update process is complete. Hence, the gateway 10 asks the user whether to authorize an update process and receives the user's selection that authorizes or suspends the update process. Based on the received selection, the gateway 10 starts the update process in the ECU 2 only if the update process is authorized. This arrangement ensures that the user can use the vehicle 1 without being disturbed by an update process.

Further in the present embodiment, if the IG signal is in the on state just at the timing of an update process in the ECU 2 or if the IG signal changes to on during an update process, the gateway 10 discontinues the transmission of the update program to the ECU 2, and allows the target ECU 2 to recover the operation using the pre-update program 22a. This arrangement enables the user to use the vehicle 1 even when the update process is in progress.

In the above-described embodiment, the gateway 10 installed in the vehicle 1 is configured to acquire update programs from the server device 9 and to transmit the update programs to the ECUs 2. Namely, the gateway 10 is configured to serve as the on-board update device. However, the on-board update device is not limited to the gateway 10, and may be any other on-board device than the gateway 10 (e.g., any one of the ECUs 2). Further, the gateway 10 is configured to acquire the update programs from the external server device 9 by wireless communication, but the update programs may be acquired in any other manner. For example, the gateway 10 may be configured to retrieve an update program from a recording medium on which the update program is recorded. Furthermore, the communication devices to be updated are not limited to the ECUs 2, but may be various communication devices other than the ECUs 2.

Regarding the server device, one server device may transmit an update program to the gateway 10, and another server device may, for example, accumulate driving information of the vehicle 1 and determine the timing of an update process based on the driving information. Furthermore, the estimation of the no-driving time slot and the determination of the update timing shown in FIG. 6 are mere examples and not limited thereto. For example, the server device 9 may take Time t2 or t0 in FIG. 6 or other moments as the update timing.

### Modified Example

In the above embodiment, the server device 9 installed outside the vehicle 1 is configured, for example, to accumulate driving information and to determine the timing of an update process. However, the device for performing such processes is not limited to this server device.

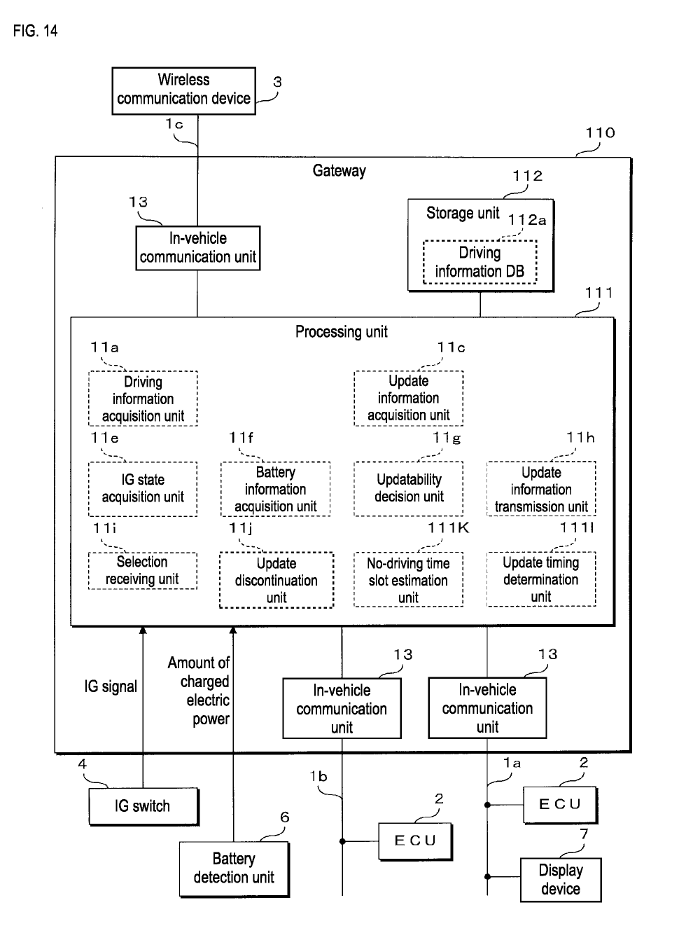

FIG. 14 is a block diagram showing the configuration of a gateway 110 according to Modified Example. In the on-board update system according to Modified Example, a gateway 110 installed in the vehicle 1 is configured, for example, to accumulate driving information and to determine the timing of an update process. The gateway 110 according to Modified Example is different from the gateway 10 shown in FIG. 4 in that a processing unit 111 includes a no-driving time slot estimation unit 111k and an update timing determination unit 111l instead of the driving information transmission unit 11b and the start command receiving unit 11d. In this gateway 110 according to Modified Example, a storage unit 112 has a driving information DB 112a.

In the gateway 110 according to Modified Example, driving information acquired by the driving information acquisition unit 11a is stored and accumulated in the driving information DB 112a provided in the storage unit 12. Based on the driving information of each vehicle 1 accumulated in the driving information DB 112a, the no-driving time slot estimation unit 111k estimates the time slot when the vehicle 1 is highly unlikely to be driving. The update timing determination unit 111l determines a specific timing in the time slot estimated by the no-driving time slot estimation unit 111k, as the timing of an update process in the vehicle 1. At the timing determined by the update timing determination unit 111l, the gateway 110 starts an update process by starting transmission of the update program acquired from the server device 9 to an ECU 2.

In the thus configured on-board update system according to Modified Example, the gateway 110 is configured to store driving information, to determine the timing of an update process based on the driving information, and to perform other relevant processes, instead of the server device 9. This on-board update system can properly determine the update timing even in a situation where the gateway 110 cannot communicate with the server device 9 frequently.

1. An on-board update system comprising:
a communication device installed in a vehicle;
a server device provided outside the vehicle; and
an on-board update device including an update information acquisition unit and an update information transmission unit, the on-board update device being configured to update a program or data stored in a storage unit of the communication device, the update information acquisition unit being configured to acquire an update program or data for updating the communication device from the server device, and the update information transmission unit being configured to transmit the update program or data acquired by the update information acquisition unit to the communication device,
wherein the on-board update device comprises:
a driving information acquisition unit configured to acquire driving information of the vehicle; and
a driving information transmission unit configured to transmit the information acquired by the driving information acquisition unit to the server device,
wherein the server device comprises:
a driving information receiving unit configured to receive the driving information of the vehicle transmitted from the on-board update device;
an update timing determination unit configured to determine, based on the information received by the driving information receiving unit, a timing of an update process in the communication device to be performed by the on-board update device; and
a start command transmission unit configured to transmit an update process start command to the on-board update device, based on the timing determined by the update timing determination unit,
wherein the on-board update device further comprises a start command receiving unit configured to receive the update process start command for the communication device from the server device, and
wherein the update information transmission unit is configured to transmit the update program or data to the communication device in accordance with the start command received by the start command receiving unit.

2. The on-board update system according to claim 1,
wherein the server device further comprises:
a driving information storage unit configured to store and accumulate the information received by the driving information receiving unit; and
a no-driving time slot estimation unit configured to estimate a time slot when the vehicle is not driving, based on the information stored in the driving information storage unit, and
wherein the update timing determination unit is configured to determine the timing of the update process, based on the time slot estimated by the no-driving time slot estimation unit.

3. The on-board update system according to claim 2,
wherein the no-driving time slot estimation unit is configured to extract one or more time slots when the vehicle was not driving, based on the information for a predetermined number of days stored in the driving information storage unit, and to estimate a longest time slot in the one or more extracted time slots as the time slot when the vehicle is not driving.

4. The on-board update system according to claim 3,
wherein the update timing determination unit is configured to determine the timing of the update process in a time range around a middle time of the time slot estimated by the no-driving time slot estimation unit, the time range corresponding to a time required for the update process in the communication device.

5. The on-board update system according to claim 1,
wherein the on-board update device further comprises:
a battery information acquisition unit configured to acquire information about an amount of electric power charged in a battery in the vehicle; and
an updatability decision unit configured to decide whether the update process in the communication device is executable, in accordance with the amount of electric power charged in the battery as acquired by the battery information acquisition unit, and
wherein the update information transmission unit is configured to transmit the update program or data to the communication device, if the updatability decision unit decides that the update process is executable.

6. The on-board update system according to claim 5,
wherein the on-board update device further comprises:
an IG (ignition) state acquisition unit configured to acquire a state of an IG signal in the vehicle; and
a selection receiving unit configured to receive a selection that authorizes or suspends the update process in the communication device, if the IG signal changes from off to on after the updatability decision unit has decided that the update process is not executable,
and
wherein the update information transmission unit is configured to transmit the update program or data to the communication device, if the selection receiving unit receives a selection that authorizes the update process.

7. The on-board update system according to claim 1,
wherein the on-board update device further comprises:
an IG (ignition) state acquisition unit configured to acquire a state of an IG signal in the vehicle; and
an update discontinuation unit configured, if the IG signal is on, to discontinue the transmission of the update program or data by the update information transmission unit and to recover an operation of the communication device using a pre-update program or data.

8. An on-board update device for updating a program or data stored in a storage unit of a communication device installed in a vehicle, the on-board update device comprising:
an update information acquisition unit configured to acquire an update program or data for updating the communication device, from a server device provided outside the vehicle; and
an update information transmission unit configured to transmit the update program or data acquired by the update information acquisition unit, to the communication device,
wherein the on-board update device further comprises:
a driving information acquisition unit configured to acquire driving information of the vehicle; and
an update timing determination unit configured to determine a timing of an update process in the communication device, based on the information acquired by the driving information acquisition unit, and
wherein the update information transmission unit is configured to transmit the update program or data to the communication device, in accordance with the timing determined by the update timing determination unit.

9. A communication device update method for updating a program or data stored in a storage unit of a communication device installed in a vehicle, by acquiring an update program or data for updating the communication device from a server device provided outside the vehicle, and transmitting the acquired update program or data to the communication device,
the method comprising the steps of
acquiring driving information of the vehicle;
transmitting the acquired information to the server device;
determining a timing of an update process in the communication device, by the server device that has received the transmitted information, based on the received information;
transmitting an update process start command, by the server device, based on the determined timing;
receiving the update process start command from the server device; and
transmitting the update program or data to the communication device in accordance with the received start command.

10. The on-board update system according to claim 2,
wherein the on-board update device further comprises:
a battery information acquisition unit configured to acquire information about an amount of electric power charged in a battery in the vehicle; and
an updatability decision unit configured to decide whether the update process in the communication device is executable, in accordance with the amount of electric power charged in the battery as acquired by the battery information acquisition unit, and
wherein the update information transmission unit is configured to transmit the update program or data to the communication device, if the updatability decision unit decides that the update process is executable.

11. The on-board update system according to claim 3,
wherein the on-board update device further comprises:
a battery information acquisition unit configured to acquire information about an amount of electric power charged in a battery in the vehicle; and
an updatability decision unit configured to decide whether the update process in the communication device is executable, in accordance with the amount of electric power charged in the battery as acquired by the battery information acquisition unit, and
wherein the update information transmission unit is configured to transmit the update program or data to the communication device, if the updatability decision unit decides that the update process is executable.

12. The on-board update system according to claim 4,
wherein the on-board update device further comprises:
a battery information acquisition unit configured to acquire information about an amount of electric power charged in a battery in the vehicle; and
an updatability decision unit configured to decide whether the update process in the communication device is executable, in accordance with the amount of electric power charged in the battery as acquired by the battery information acquisition unit, and
wherein the update information transmission unit is configured to transmit the update program or data to the communication device, if the updatability decision unit decides that the update process is executable.

13. The on-board update system according to claim 2,
wherein the on-board update device further comprises:
an IG (ignition) state acquisition unit configured to acquire a state of an IG signal in the vehicle; and
an update discontinuation unit configured, if the IG signal is on, to discontinue the transmission of the update program or data by the update information transmission unit and to recover an operation of the communication device using a pre-update program or data.

14. The on-board update system according to claim 3,
wherein the on-board update device further comprises:
an IG (ignition) state acquisition unit configured to acquire a state of an IG signal in the vehicle; and
an update discontinuation unit configured, if the IG signal is on, to discontinue the transmission of the update program or data by the update information transmission unit and to recover an operation of the communication device using a pre-update program or data.

15. The on-board update system according to claim 4,
wherein the on-board update device further comprises:
an IG (ignition) state acquisition unit configured to acquire a state of an IG signal in the vehicle; and
an update discontinuation unit configured, if the IG signal is on, to discontinue the transmission of the update program or data by the update information transmission unit and to recover an operation of the communication device using a pre-update program or data.

16. The on-board update system according to claim 5,
wherein the on-board update device further comprises:
an IG (ignition) state acquisition unit configured to acquire a state of an IG signal in the vehicle; and
an update discontinuation unit configured, if the IG signal is on, to discontinue the transmission of the update program or data by the update information transmission unit and to recover an operation of the communication device using a pre-update program or data.

17. The on-board update system according to claim 6,
wherein the on-board update device further comprises:
an IG (ignition) state acquisition unit configured to acquire a state of an IG signal in the vehicle; and
an update discontinuation unit configured, if the IG signal is on, to discontinue the transmission of the update program or data by the update information transmission unit and to recover an operation of the communication device using a pre-update program or data.
